(19) United States
(12) Patent Application Publication
(10) Pub. No.: US 2008/0220276 A1
(43) Pub. Date: Sep. 11, 2008

(54) Veneered cutting board with resin-impregnated core

(76) Inventors: Leland R. Miller, Oconomowoc, WI (US); Dennis H. Theune, Crandon, WI (US); Christopher T. Leach, Crandon, WI (US)

Correspondence Address: SEYFARTH SHAW LLP, 131 S. DEARBORN ST., SUITE 2400, CHICAGO, IL, 60603-5803, US

(21) Appl. No.: 11/715,830

(22) Filed: Mar. 8, 2007

(51) Int. Cl. B32B 21/14; B29C 43/00

(52) U.S. Cl. 428/535; 264/500

(57) ABSTRACT

A laminate board for use as a cutting board is disclosed having a core made of a resin-impregnated cellulosic material and a first wood veneer bonded to an exterior of the core. A second wood veneer bonded to an exterior of the core opposite the first wood veneer may be used to create a double-faced laminate board. The use of multiple barrier layers interposed between the core and the wood veneers prevents leaching of resin material into the veneers. Preferably, the core of the board is made of a laminate of phenolic-impregnated papers. A second resin-impregnated cellulosic material provides the barrier protection between the veneer and core layers. Preferably, the resin-impregnated barrier layer is made from at least one of either acrylic-impregnated paper, styrene-butadiene impregnated paper, acrylic-coated paper, catalyzed (fast or slow cycle) melamine-impregnated paper, and blends thereof. The method of manufacturing the board is also disclosed.

### TECHNICAL FIELD OF THE INVENTION

The present device relates to laminate boards having a veneered outer surface, such as a kitchen cutting board and the like. Particularly, the present device relates to a veneered board having a resin-impregnated core.

### BACKGROUND OF THE INVENTION

A cutting board is a general term used to describe a kitchen utensil which provides a flat surface on which to cut or slice food items. Such boards, for purposes of the present application, include chopping blocks, carving boards, cheese boards, serving boards, and the like. Cutting boards are often made of wood or plastic, and some chopping boards are made of glass-which is easier to clean than wood or plastic, but can be damaging to knives.

Wood boards are preferred over plastic and glass for several reasons. It has been shown that wood surfaced boards inhibit bacterial growth on the cutting surface, whereas plastics do not. Wood boards can be made from a variety of beautifully-grained hardwoods and softwoods, with maple and pine being the most popular, which may give a kitchen a much more attractive look than plastic boards. The wood board is less damaging to a sharp knife, even very good knives, than a glass board. The natural grain of the wood also helps keep the food from slipping, while plastic and glass surfaces must be textured to achieve this feature.

However, with the growing scarcity and cost of quality lumber, the fabrication of a dimensionally stable and inexpensive composite board has long been a challenge to the wood products industry. Layer separation, warping, instability of materials due to moisture, leaching of materials, expensive manufacturing processes and other problems have plagued attempts in the industry to create a suitable composite cutting board.

The cutting board of this invention has overcome prior art problems and provides an inexpensive, easily constructed, dimensionally stable cutting board capable of withstanding continued use and exposure to moisture and other elements encountered in a household. Disclosed is a board which is decorative, yet functional; versatile as a board for cutting, slicing, chopping and serving any number of food items; and is easy and inexpensive to manufacture.

### SUMMARY OF THE INVENTION

In a first embodiment of the disclosed laminate structure, a cutting board comprises a core made of a resin-impregnated cellulosic material and a first wood veneer bonded to an exterior of the core. A second wood veneer bonded to an exterior of the core opposite the first wood veneer may be used to create a double-faced laminate board. The use of multiple barrier layers interposed between the core and the wood veneers prevent leaching of resin material into the veneers.

It is an aspect of an embodiment of the present invention to provide the resin-impregnated cellulosic material as a phenolic-impregnated paper. Preferably, the core comprises a plurality of phenolic-impregnated papers. A second resin-impregnated cellulosic material provides the barrier protection between the veneer and core layers. Preferably, the resin-impregnated barrier layer comprises one of either a fast-cycle melamine-impregnated paper, an acrylic-impregnated paper, or some combination of the two.

It is also an aspect of the present invention to provide a method of constructing a cutting board comprising the steps of arranging a laminate, heating the laminate to a temperature in the range of from about 285° F. (141° C.) to about 350° F. (177° C.), preferably about 305° F. (152° C.), and applying pressure within the range of from about 300 psi (20.7 bar) to about 1200 psi (82.7 bar), preferably about 500 psi (34.5 bar), to the laminate for a time. The laminate preferably comprises a core made of a resin-impregnated cellulosic material, a first wood veneer adjacent the core, a second wood veneer adjacent the core opposite the first wood veneer, and at least one barrier layer interposed between the core and at least one of either the first wood veneer and the second wood veneer. Preferably, the resin-impregnated cellulosic material is phenolic-impregnated paper and the barrier layers are selected from at least one of acrylic-impregnated paper, melamine-impregnated paper, and any combination of these papers.

These and other aspects of the invention may be understood more readily from the following description and the appended drawings.

### BRIEF DESCRIPTION OF THE DRAWINGS

For the purpose of facilitating an understanding of the subject matter sought to be protected, the accompanying drawings illustrate embodiments thereof, from an inspection of which, when considered in connection with the following description, the subject matter sought to be protected, its construction and operation, and many of its advantages should be readily understood and appreciated.

FIG. 1 is a schematic of a first embodiment of the composition for a laminate structure of the present invention;

FIG. 2 is a schematic of another embodiment of the composition for a laminate structure of the present invention;

FIG. 3 is a schematic of still another embodiment of the composition for a laminate structure of the present invention;

FIG. 4 is a schematic of still a fourth embodiment of the composition for a laminate structure of the present invention; and

FIG. 5 is a schematic of a fifth embodiment of the composition for a laminate structure of the present invention.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

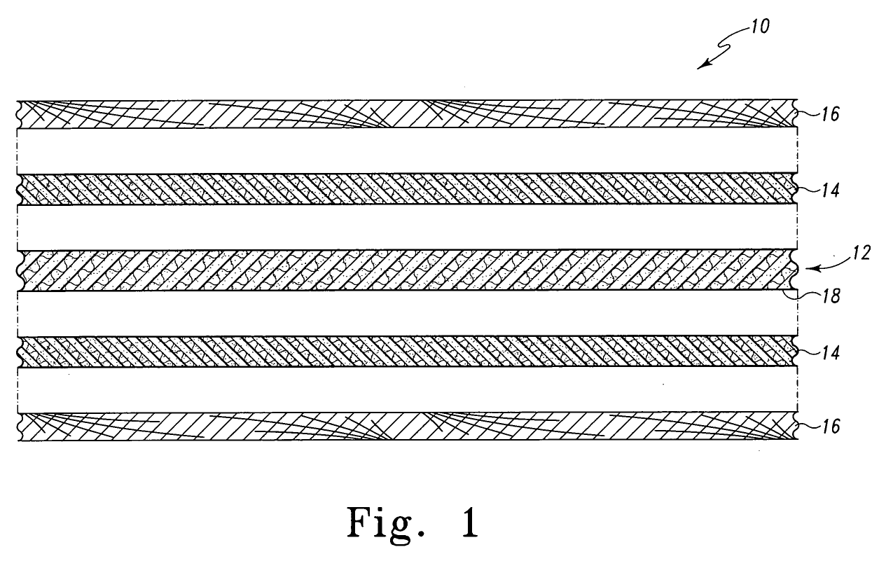

Referring to FIGS. 1-5, there is illustrated multiple embodiments of a laminate cutting board, generally designated by a number ending with the numeral 10. Similar components in different embodiments are distinguished using a leading number, such as 20, 120, and 220.

Generally speaking, the cutting board 10, as show in FIG. 1, is comprised of a combination of three distinct layers: core 12, a barrier layer 14, and wood veneer 16. The particular embodiment of FIG. 1 is a five-layer laminate including a core 12, first and second barrier layers 14, and first and second veneers 16. This embodiment is considered a double-faced board because it is veneered on both sides.

The core 12 is comprised of a plurality of cellulosic material sheets, such as those made from paper, cardboard, wood, and other fibrous plant material. The core 12 may be formed as a laminate itself prior to the construction of the laminate board or, as is preferred, it may be constructed as part of the board 10, as will be discussed in more detail below. The paper of the core 12 is preferably standard kraft paper which, as known by those skilled in the art, may vary in dimensional thickness. Thicknesses which are readily impregnated with a resin are preferred. The individual paper sheets 18 of core 12 are most preferably phenolic-impregnated paper manufactured and sold by Fiberesin Industries, Inc., Oconomowoc, Wis. The number of paper sheets 18 used for the core 12 depends on the desired thickness and strength of the resulting board 10. The number of paper sheets 18 preferably falls within the range of 4-60 sheets.

The resin of the core 12 has a tendency, especially under pressure, to leach into adjacent layers of the cutting board 10 during processing. Accordingly, a barrier layer 14 may be interposed between the core 12 and any additional layers to prevent leaching. The barrier layer 14 is also preferably a resin-impregnated cellulosic material, but may be a coated material in certain applications. A single sheet of material may be used for barrier layer 14, with the preferred layer being comprised of at least one of either acrylic-impregnated paper, styrene-butadiene impregnated paper, acrylic-coated paper, catalyzed (fast or slow cycle) melamine-impregnated paper, and blends thereof. Fast-cycle (highly catalyzed) melamine-impregnated paper is the most preferred material for use as a barrier layer. Low and very low level catalyzed melamine resins are not as effective barrier papers, and may require multiple sheets for a proper barrier layer. The melamine-impregnated paper with about 50-70% resin content has been found, based on the method described below, to most readily bond to the core and protect against leaching of the phenolic resin.

The third layer of the laminate is wood veneer 16. This layer is largely decorative, giving the resulting board an outwardly wood look and feel. The wood veneer 16 may be either a hardwood, preferably maple, or even a softwood, like pine, in some applications. Also, the veneer 16 is preferably applied as a sheet having a width greater than 3 inches (7.6 cm), and most preferably a sheet having a width equal to that of the desired board 10. Alternatively, the veneer 16 may take the form of wood strips no more than about 3 inches (7.6 cm) wide. The strips would need to be tightly aligned at abutting edges and could alternate different woods, grain patterns, and the like, for aesthetic purposes.

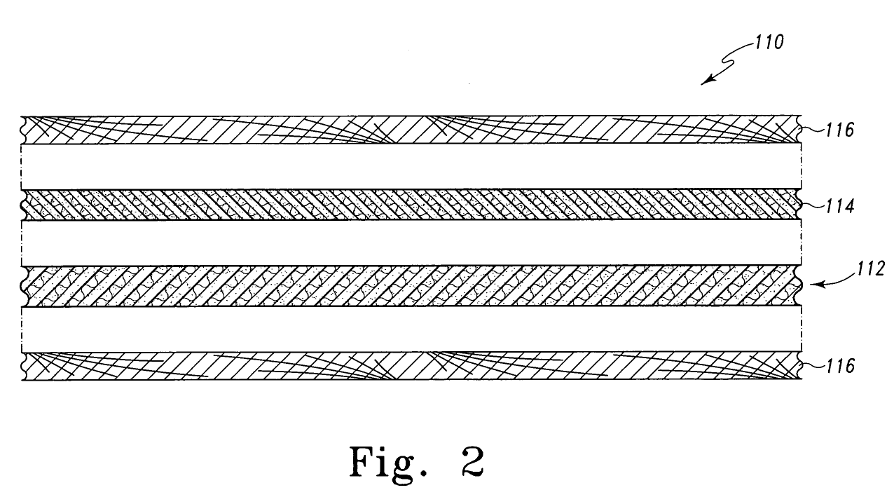

Referring now to the drawings of FIGS. 2-5, different combinations of the three materials described above may be used to construct alternate embodiments of the present cutting board. While the description of the invention focuses on the use as a cutting boards, certain of the embodiments may have applications in other related and unrelated fields.

FIG. 2 illustrates board 110 as a four layer laminate. A core 112 is used with a single barrier layer 114 and first and second veneers 116. Where a bottom (or second) veneer surface is to have, for example, some type of affixed feature, such as a slip-resistant material, design, feet, etc., which would make the surface unsuitable for cutting food items, a second barrier layer may be omitted.

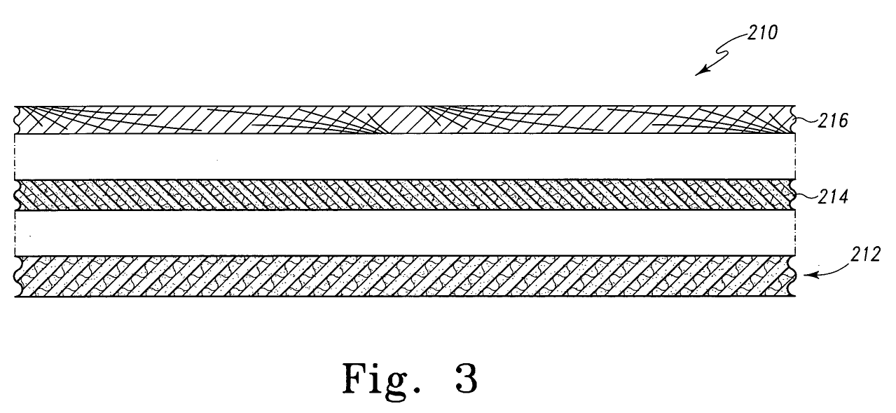

Similarly, FIG. 3 illustrates a three-layer laminate board 210 having a core 212, a barrier layer 214 and a single wood veneer 216. This embodiment of cutting board 210 might be used as a kitchen counter-top inlay, for example.

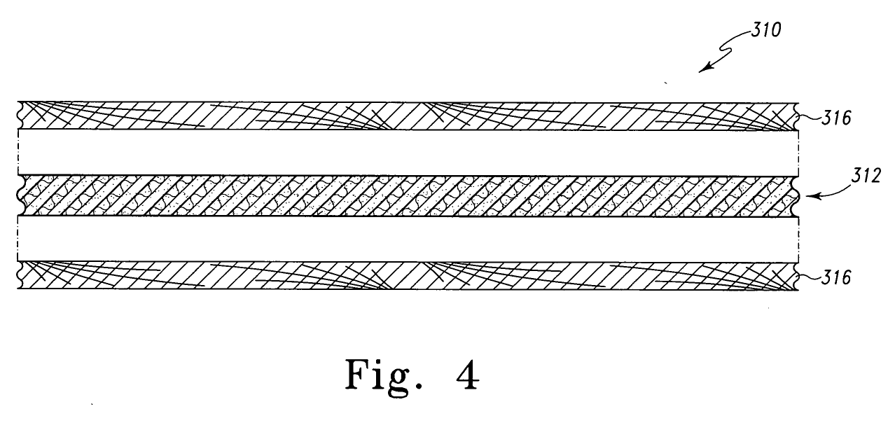

Referring to FIG. 4, this embodiment of cutting board 310 includes a phenolic-impregnated core 312 with first and second veneers 316 bonded to the core 312. The leaching of the phenolic resin from the core 312 to the veneers 316 may be either controlled during the forming process, as described below, or tolerated due to a unique use for the resulting board 310.

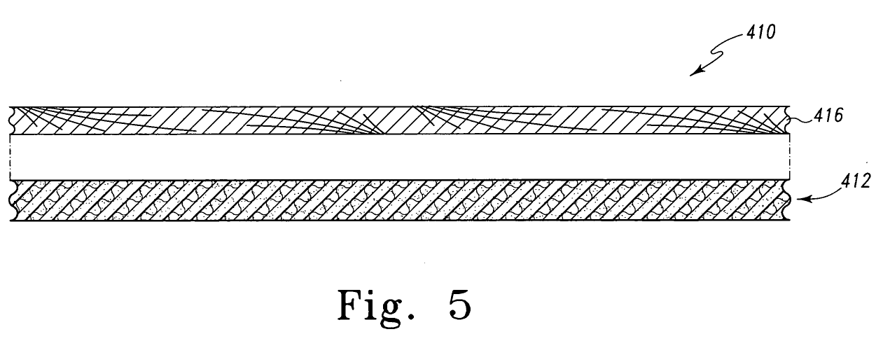

Finally, FIG. 5 illustrates the most basic embodiment of the present cutting board 410. The board 410 comprises a phenolic-impregnated core 412 and a veneer 416 bonded to one face of the core 412. This is known in the industry as a single-faced laminate. Like the embodiment of FIG. 3, this board 410 may be provided as a counter-top inlay, or some similar use.

Each of the disclosed embodiments of FIGS. 1-5 is manufactured in a similar manner. However, for purposes of describing the process, reference is hereby made to FIG. 1. The embodiments of remaining FIGS. 2-5 can be obtained by omitting the necessary material as described above.

A batch press machine (not shown) is used to manufacture the raw cutting board 10 of FIG. 1. The batch press machine is well-known to those skilled in the art. A continuous press machine may be used where such materials are capable of being somewhat continuously provided to the machine. However, the press time makes the process more likely suitable for batch mode manufacture.

The upper and lower plates of the press machine are preferably heated to within the desired temperature range for operation. A first veneer 16 is placed onto the lower plate of the batch press machine (not shown) and is then overlayed with a single sheet of resin-impregnated barrier paper 14. In some instances more than a single barrier sheet may be needed to prevent core resin bleed-through. The desired number of core resin-impregnated papers 18 are then aligned within the press machine to achieve a desired board thickness. As stated previously, though not preferred for present applications, the core 12 may be initially constructed as a laminate before being placed within the board 10 construction. Another barrier layer 14 then follows the core 12, and a second veneer 16 completes the construction.

The press is then activated to apply a pressure to the construction of approximately 500 psi, at least preferably within the range of 300 to 1200 psi, with the temperature of the press plates being held in the 285-350° F. range, preferably at 305° F. The curing of the impregnated resins is an exothermic reaction, so close monitoring of the temperature may be required. The press is held within these parameters for approximately 11 minutes to produce the finished laminate board.

The press plates are then opened and the resulting laminate board is removed and finished for retail. The finish process may include trim-cutting excess material, shaping edges of the board, sanding outer and edge surfaces, cleaning outer surfaces, treating, sealing, and trimming out the board for use and other necessary processes known to those skilled in the art.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A laminate cutting board comprising:
a core comprised of a resin-impregnated cellulosic material; and
a first wood veneer bonded to an exterior of the core.

2. The laminate of claim 1, further comprising a second wood veneer bonded to an exterior of the core opposite the first wood veneer.

3. The laminate cutting board of claim 1, further comprising a barrier layer interposed between the core and the first wood veneer.

4. The laminate cutting board of claim 2, further comprising a barrier layer interposed between each the core and the first wood veneer and the core and the second wood veneer.

5. The laminate cutting board of claim 2, further comprising a barrier layer interposed between at least one of either the first and second wood veneers.

6. The laminate cutting board of claim 1, wherein the resin-impregnated cellulosic material is phenolic-impregnated paper.

7. The laminate cutting board of claim 3, wherein the core comprises a laminate of phenolic-impregnated papers.

8. The laminate cutting board of claim 2, wherein the first and second wood veneers are selected from a group consisting of hardwoods and softwoods.

9. The laminate cutting board of claim 2, wherein the first and second wood veneers comprise a plurality of strips, each having a width of less than approximately 3 inches (7.6 cm).

10. The laminate cutting board of claim 2, wherein the first and second wood veneers comprise a sheet having a width greater than approximately 3 inches (7.6 cm).

11. The laminate cutting board of claim 3, wherein the barrier layer comprises a resin-impregnated paper.

12. The laminate cutting board of claim 11, wherein the resin-impregnated barrier layer comprises catalyzed melamine-impregnated paper.

13. The laminate cutting board of claim 11, wherein the resin-impregnated barrier layer comprises acrylic-impregnated paper.

14. The laminate cutting board of claim 4, wherein the barrier layers comprise a resin-impregnated paper selected from the group consisting of at least one of either acrylic-impregnated paper, styrene-butadiene impregnated paper, acrylic-coated paper, catalyzed (fast or slow cycle) melamine-impregnated paper, and blends thereof.

15. The laminate cutting board of claim 14, wherein the resin-impregnated barrier layers comprise catalyzed melamine-impregnated paper.

16. The laminate cutting board of claim 14, wherein the resin-impregnated barrier layers comprise acrylic-impregnated paper.

17. A double-faced laminate comprising:
a core comprised of a resin-impregnated cellulosic material;
a first wood veneer bonded to an exterior of the core; and
a second wood veneer bonded to an exterior of the core opposite the first wood veneer.

18. The double-faced laminate of claim 17, further comprising a barrier layer interposed between the core and at least one of either the first and second wood veneers.

19. The double-faced laminate of claim 17, wherein the resin-impregnated cellulosic material is phenolic-impregnated paper.

20. The double-faced laminate of claim 18, wherein the core comprises a laminate.

21. The double-faced laminate of claim 20, wherein the core laminate comprises phenolic-impregnated papers.

22. The double-faced laminate of claim 17, wherein the first and second wood veneers are selected from a group of woods consisting of hardwood and softwood.

23. The double-faced laminate of claim 17, wherein the first and second wood veneers comprise a plurality of adjacent strips, each having a width of no more than 3 inches (7.6 cm).

24. The double-faced laminate of claim 17, wherein the first and second wood veneers comprise a sheet having a width of at least 3 inches (7.6 cm).

25. The double-faced laminate of claim 18, wherein the barrier layer comprises a second resin-impregnated cellulosic material.

26. The double-faced laminate of claim 25, wherein the second resin-impregnated cellulosic material is selected from the group consisting of at least one of either acrylic-impregnated paper, styrene-butadiene impregnated paper, acrylic-coated paper, catalyzed (fast or slow cycle) melamine-impregnated paper, and blends thereof.

27. A cutting board comprising:
a core comprised of a resin-impregnated cellulosic material;
a first wood veneer adjacent the core;
a second wood veneer adjacent the core opposite the first wood veneer; and
at least one barrier layer interposed between the core and at least one of either the first wood veneer and the second wood veneer.

28. The cutting board of claim 27, wherein a barrier layer is interposed between the core and each of the first wood veneer and the second wood veneer.

29. The cutting board of claim 27, wherein the resin-impregnated cellulosic material is a laminate.

30. The cutting board of claim 29, wherein the resin-impregnated cellulosic material is phenolic-impregnated paper.

31. The cutting board of claim 29, wherein the laminate comprises phenolic-impregnated papers.

32. The cutting board of claim 27, wherein the first and second wood veneer comprise maple.

33. The cutting board of claim 27, wherein the first and second wood veneers comprise a plurality of wood strips, each no more than 3 inches (7.6 cm) wide.

34. The cutting board of claim 27, wherein the first and second wood veneers comprise a single sheet of wood at least 3 inches (7.6 cm) wide.

35. The cutting board of claim 27, wherein the barrier layer comprises an acrylic-impregnated paper.

36. The cutting board of claim 27, wherein the barrier layer comprises catalyzed melamine-impregnated paper.

37. A method of constructing a cutting board comprising the steps of:
arranging a layered assembly comprising:
a core comprised of a resin-impregnated cellulosic material;
a first wood veneer adjacent the core;
a second wood veneer adjacent the core opposite the first wood veneer; and
at least one barrier layer interposed between the core and at least one of either the first wood veneer and the second wood veneer;
heating the layered assembly to a temperature in the range of from about 285° F. (141° C.) to about 350° F. (177° C.); and
applying pressure within the range of from about 300 psi (20.7 bar) to about 1200 psi (82.7 bar) to the layered assembly for a time.

38. The method of claim 37, wherein the temperature is about 305° F. (152° C.).

39. The method of claim 37, wherein the pressure is about 500 psi (34.5 bar).

40. The method of claim 37, wherein the resin-impregnated cellulosic material is phenolic-impregnated paper.

41. The method of claim 37, wherein the barrier layer is selected from the group consisting of at least one of either acrylic-impregnated paper, styrene-butadiene impregnated paper, acrylic-coated paper, catalyzed (fast or slow cycle) melamine-impregnated paper, and blends thereof.

42. A method of constructing a laminate board comprising the steps of:
arranging a layered assembly comprising:
a core comprised of a resin-impregnated cellulosic material;
a first wood veneer adjacent the core;
a second wood veneer adjacent the core opposite the first wood veneer; and
at least one barrier layer interposed between the core and at least one of either the first wood veneer and the second wood veneer;
heating the layered assembly to a temperature in the range of from about 285° F. (141° C.) to about 350° F. (177° C.); and
applying pressure within the range of from about 300 psi (20.7 bar) to about 1200 psi (82.7 bar) to the layered assembly for a time.

43. The method of claim 42, wherein the temperature is about 305° F. (152° C.).

44. The method of claim 42, wherein the pressure is about 500 psi (34.5 bar).

45. The method of claim 42, wherein the resin-impregnated cellulosic material is phenolic-impregnated paper.

46. The method of claim 42, wherein the barrier layer is selected from the group consisting of at least one of either acrylic-impregnated paper, styrene-butadiene impregnated paper, acrylic-coated paper, catalyzed (fast or slow cycle) melamine-impregnated paper, and blends thereof.
